(19) United States
(12) Patent Application Publication
(10) Pub. No.: US 2006/0207188 A1
(43) Pub. Date: Sep. 21, 2006

(54) Ceria abrasive for cmp

(76) Inventors: Un-Gyu Paik, Seoul (KR); Jea-Gun Park, Sung-Nam (KR); Sang-Kyun Kim, Busan (KR); Takeo Katoh, Seoul (KR); Yong-Kook Park, Seoul (KR)

Correspondence Address: MARGER JOHNSON & MCCOLLOM, P.C., 210 SW MORRISON STREET, SUITE 400, PORTLAND, OR, 97204, US

(21) Appl. No.: 10/550,804

(22) PCT Filed: May 14, 2004
(86) PCT No.: PCT/KR04/01139

§ 371 Date: Sep. 22, 2005

(30) Foreign Application Priority Data
May 15, 2003 (KR) 1020030030880

(51) Int. Cl. C09K 3/14

(52) U.S. Cl. 51/298; 51/309

(57) ABSTRACT

The present invention relates to a CMP abrasive comprising a ceria slurry and a chemical additive having two or more functional groups by mixing and synthesizing a polymeric molecule and a monomer. Also, the present invention relates to a method for a manufacturing CMP abrasive by providing a ceria slurry, manufacturing a chemical additive having two or more functional groups by mixing and synthesizing of the polymeric molecule and the monomer in a reactor, and mixing said slurry and said chemical additive. Therefore, when the abrasive according to the present invention is used as an STI CMP abrasive, it is possible to apply the abrasive to the patterning process required in the very large scale integration semiconductor process. Furthermore, the CMP abrasive of the present invention has a superior removal rate, superior polishing selectivity, superior within wafer non-uniformity (WIWNU), and minimized occurrence of micro scratches.

### TECHNICAL FIELD

The present invention relates to an abrasive used in a chemical mechanical polishing (CMP) process in the manufacturing process of a semiconductor device with a multi-layer metal wiring structure and a method for manufacturing the abrasive, in detail to an abrasive used in the CMP process of an STI (Shallow Trench Isolation) process, which is essentially employed in the manufacturing process of very large scale integration semiconductors of over 256 megabyte DRAMs (with a design rule of below 0.13 μm) and a method for manufacturing said abrasive.

### BACKGROUND ART

A local oxidation of silicon (LOCOS) process, which is a conventional insulating process of a semiconductor element device, reaches its limits when a design rule falls to below 0.25 μm. As a substitute for the LOCOS process, a novel STI process has been introduced.

Referring to FIG. 7, such an STI process will be briefly explained below. Such an STI process is, as shown in FIG. 7 (a), performed by depositing nitride film (Si₃N₄ film) 13 on a surface of a silicon wafer 11, patterning the nitride film 13 (see FIG. 7 (b)), and forming trenches (which are denoted by reference numeral 15 in FIG. 7 (c)) in insulating areas between the portions where electronic elements are formed. Then, after the trenches 15 are filled with insulating material, i.e., oxide film (SiO₂ film) 17 (see FIG. 7 (d)), a planarization process is performed by removing the oxide film using the CMP process (see FIG. 7 (e))

At this time, in order to remove damage to the silicon wafer, the CMP process should be stopped when the nitride film for protecting the elements is exposed. Otherwise, the oxide film and the nitride film pattern are simultaneously polished during the global planarization process, causing a dishing phenomenon wherein oxide film is excessively removed due to loss of the nitride film pattern to occur as shown in the dotted line in FIG. 7 (e). Therefore, the abrasive used in the STI CMP process is required to have a high selectivity of oxide film to nitride film.

The STI CMP process is a technique for achieving the global planarization. In the STI CMP process, the surface of the wafer is chemically reacted with slurry chemistry while the surface of the wafer is in contact with an elastic polishing pad. At the same time, the oxide film on the surface of the wafer is removed mechanically by moving a platen and a wafer holder. The combination of mechanical effects and chemical reactions results in material removal form the surface of the wafer. Then, the polishing process is stopped when the nitride film is exposed, so that insulation between elements and the global planarization of the surface of the wafer are achieved.

Such an STI CMP abrasive requires high selectivity, polishing rate, dispersion stability, and micro-scratch stability. Particle size distribution should be narrow and uniform, and the number of large particles over a predetermined size, for example 1 μm should be in a predetermined range.

A prior art method for manufacturing such an STI CMP abrasive is disclosed in U.S. Pat. No. 6,221,118 published on Apr. 24, 2001, entitled ‘Cerium oxide abrasive and method of polishing substrates,’ and assigned to Htachi Chemical Company, Ltd. In this publication, an abrasive manufacturing method using polymer and particles, which meet the requirements of properties of the STI CMP abrasive, is described difficultly and discussed at large.

Another prior art is disclosed in U.S. Pat. No. 6,420,269 published on Jul. 16, 2002, entitled ‘Cerium oxide abrasive for polishing insulating films formed on substrate and methods for using the same,’ and assigned to Htachi Chemical Company, Ltd. However, in this publication, while only fundamental properties of selectivity and polishing rate are described, uses and amounts of added chemicals and particle size distribution, viscosity, number of large particles over 1 μm, and the like, which are required as properties of a semiconductor STI CMP abrasive of especially high selectivity, are not concretely described.

Therefore, in order to manufacture a CMP abrasive of high quality, it is required to concretely and synthetically research properties applied to various semiconductor patterns, particle size distribution, viscosity, and behavior of large particles over 1 μm.

### DISCLOSURE OF INVENTION

### Technical Problem

It is an abject of the present invention to provide a CMP abrasive which, in order to solve problems caused in the prior arts, is necessary for the STI CMP process of manufacturing very large scale integration semiconductors with a design rule below 0.25 μm using known conventional dispersion apparatuses and techniques, and a method for manufacturing the same.

It is also an abject of the present invention to provide a CMP abrasive which has polishing properties with a high selectivity to be applied to various patterns by mixing a chemicall additive to a slurry and restrains micro scratches, which are fatal in the semiconductor manufacturing processes after the CMP process, and a method for manufacturing the same.

In addition, it is noted that the ceria slurry and the chemical additive are separately manufactured so that the CMP abrasive of the present invention controls a polishing rate of the oxide film and has high selectivity of oxide film to nitride film.

### Technical Solution

In one aspect of the present invention, a CMP abrasive comprises a ceria slurry and a chemical additive having two or more functional groups by mixing and synthesizing a polymeric molecule and a monomer.

The ceria slurry may comprise ceria powder, water and negative-ion-based polymeric compound and conform to a Newtonian viscosity behavior. The negative-ion-based polymeric compound may be selected from the group consisting of polymethacrylic acid, ammonium polymethacrylate, polycarboxylate, and carboxyle-acryl polymer. In the chemical additive, the polymeric molecule may be polyacrylic acid (PAA) or alkyl methacrylate, and the monomer may be selected from the group consisting of acrylamide, methacrylamide ethyl-methacrylamide, vinylpyridine, and vinylpyrrolidone. Mixing ratio of the slurry to the chemical additive may be 1:1.

In another aspect of the present invention, a method for manufacturing a CMP abrasive-comprises steps of providing a ceria slurry, manufacturing a chemical additive having two or more functional groups by mixing and synthesizing a polymeric molecule and a monomer in a reactor, and mixing said slurry and the chemical additive.

The step of providing a ceria slurry may comprise steps of manufacturing ceria by solid-phase synthesis, mixing said ceria with water, milling said mixture with a high energy attrition mill, dispersing said milled resultant with a high pressure dispersion apparatus, and dispersion stabilizing said dispersed resultant by adding negative-ion-based polymeric compound. The negative-ion-based polymeric compound of 0.0001˜10% by weight may be added. After the step of dispersion stabilizing, the method for manufacturing a CMP abrasive may further comprise a step of removing large particles with a filter. The molecular weight of the polymeric molecule may be 2,000˜1,000,000. The step of manufacturing a chemical additive may further comprise a step of adding further solvent to the synthesized chemical additive. The step of adding further solvent may cause the synthesized chemical additive to be 0.03˜10% by weight.

### DESCRIPTION OF DRAWINGS

FIG. 1 is a schematic view showing a manufacturing process of a ceria CMP abrasive of the present invention.

FIG. 2 is a view showing an experimental result for viscosity behavior of the CMP slurry according to an embodiment of the present invention.

FIG. 3 is a view showing an experimental result for remaining particles in oxide film among abrasion properties of a conventional abrasive.

FIG. 4 is a view showing an experimental result for remaining particles in oxide film among abrasion properties of the CMP abrasive according to an embodiment of the present invention.

FIG. 5 is a view showing an experimental result for remaining particles in nitride film among abrasion properties of the conventional abrasive.

FIG. 6 is a view showing an experimental result for remaining particles in nitride film among abrasion properties of the CMP abrasive according to the embodiment of the present invention.

FIG. 7 is a flow chart explaining an STI process.

### BEST MODE

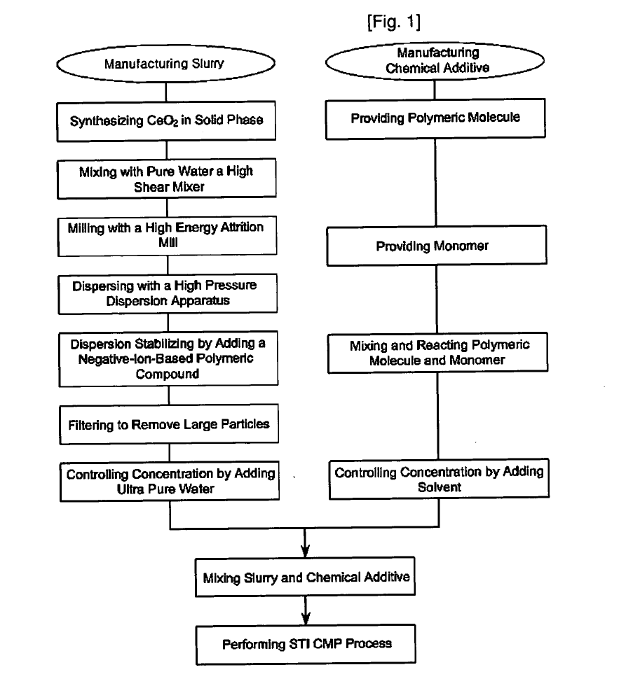

Referring to FIG. 1, methods for manufacturing a ceria slurry and a chemical additive will be explained below.

Manufacture of Ceria Slurry

The ceria slurry is manufactured by steps of manufacturing ceria by solid-phase synthesis, mixing the ceria with water, milling the mixture with a high energy attrition mill, dispersing the milled resultant with a high pressure dispersion apparatus, and stabilizing the dispersed resultant by adding a negative-ion-based polymeric compound.

Each of the steps will be explained in detail below.

Ceria particles to be used in the present invention are synthesized by solid-phase synthesis, and then the synthesized ceria particles are mixed with ultra pure water in a high shear mixer. Next, in order to control the size of the mixed abrasive particles, the mixed abrasive particles are milled in a high energy attrition mill. With a concentration of abrasive particles maintained at 10˜50% by weight, a mixing ratio of 20˜40% by weight is preferable.

A slurry with particle size distribution of 100˜250 nm is achieved by controlling the revolution speed of the high energy attrition mill to 900˜1600 rpm during the milling process. The milled slurry, which is transferred with a pump to an appropriate dispersion apparatus such as a media mill and a high pressure dispersion apparatus, is dispersed. Although it is possible to use any dispersion apparatus, taking reproducibility of dispersion, minimization of potential contamination in the dispersion process, average particle size and dispersion thereof after dispersing, and the like into consideration, it is preferable to use a high pressure dispersion apparatus.

Although the high pressure dispersion apparatus commercially available under the Microfluidizer from Microfluiducs Corp., the Nanomier from Nanomizer, or the like was used in the present invention, other dispersion apparatuses may be used. In the meantime, taking durability into consideration, it is preferable to use large diamond particles as large particles for dispersion with high hardness, which are the core of the high pressure dispersion apparatus.

The proper pressure for high pressure dispersion is preferably in the range of 10,000˜20,000 psi. While pressure below 10,000 psi causes insufficient dispersion efficiency, pressure of over 20,000 psi affects adversely efficiency of the apparatus and durability of the large particles. Thus, it is preferable to perform the dispersion process at the above range of pressures.

Since the process for controlling average particle size of the slurry is finished, by adding negative-ion-based polymeric compound, the interface potential of the ceria particles becomes negative in the range of neutral pH and simultaneously the ceria particles are stabilized.

An example of the negative-ion-based polymeric compound used here is preferably selected from the group consisting of polymethacrylic acid, ammonium polymethacrylate, polycarboxylate and carboxyle-acryl polymer.

Solubility of the polymeric compound with respect to water is considered as one of the fundamental properties. The added amount of the negative-ion-based polymeric compound is preferably in the range of 0.0001˜10.0%, more preferably 0.001˜3.0%, most preferably 0.02˜2.0% by weight of the amount of abrasive particles. Positive ionic matter may cause re-cohesion between the particles in the dispersed slurry even in the case of a molecular weight of over 10,000, with the result that generation of large particles may be promoted.

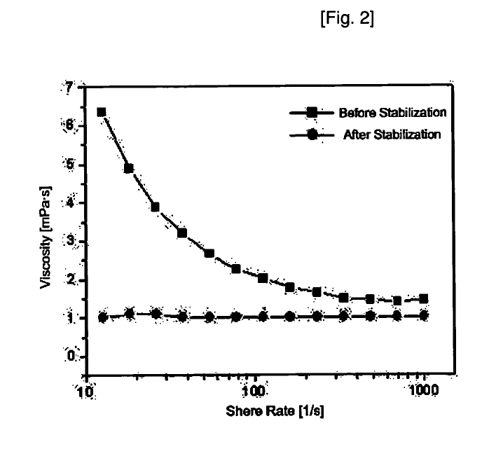

It is preferable that the stabilized ceria slurry conforms to a Newtonian viscosity behavior, the Theological properties of which is explained in detain in FIG. 2. That is to say, as shown in FIG. 2, while the viscosity of the slurry before the dispersion stabilization varies inversely with the shear rate, the viscosity of the slurry after dispersion stabilization does not vary according to shear rate, that is, it conforms to Newtonian behavior. After the dispersion stabilizing process of the slurry, the particle size distribution of the abrasive particles in the slurry may be controlled by removing large particles with a filter.

As a final step, since it is preferable that the slurry manufactured as above is mixed with a chemical additive, which will be described below, immediately before the CMP process, the concentration of the slurry is controlled by adding ultra pure water.

According to the present invention, if a polymeric compound or negative ionic matter of molecular weight of below 10,000 is added to the slurry, the polymer or the like is adsorbed into the surfaces of the ceria particles i.e., the abrasive. Thus, the interface potential of the ceria particles becomes negative in the range of neutral pH, and simultaneously surface potential is also increased, so that the dispersion stabilization of the abrasive can be maintained. Therefore, the abrasive, which is required in the STI CMP process, can be given polishing properties, such as average particle size, dispersion stability, viscosity, the number of large particles, and the like, polishing rate within wafer non-uniformity (WIWNU), micro scratches, and the like.

Manufacture of Chemical Additive

As shown in FIG. 1 again, the chemical additive is manufactured by steps of providing raw materials of a polymeric molecule and a monomer, mixing and reacting the raw materials with solvent, and controlling mixing concentration by adding further solvent to the mixture obtained in the previous step.

In the chemical additive, which has two or more functional groups by mixing the polymeric molecule and the monomer used in the present invention, a polymer consisting of two functional groups is referred to as a copolymer, the polymer manufactured in the present invention is referred to as a multi-functional polymer or a graft copolymer.

Polyacrylic acid (PAA) or alkyl methacrylate is used herein as an example of the polymeric molecule, and acrylamide, methacrylamide, ethyl-methacrylamide, vinylpyridine, or vinylpyrrolidone is used herein as an example of the monomer. The chemical additive is manufactured by mixing and synthesizing them in a reactor. The molecular weight of polyacrylic acid (PAA) or alkyl methacrylate is preferably 2,000˜1,000,000, more preferably 5,000˜500,000, most preferably 10,000˜100,000.

The chemical additive synthesized in the reactor may be applied to various processes including patterning required in the semiconductor processes according to the respective functional groups of the synthesized polymer. The added amount of the synthesized chemical additive is preferably in the range of 0.03˜10%, more preferably 0.05˜5%, most preferably 0.1˜3% by weight of the amount of solvent added.

The CMP abrasive, which is obtained by mixing the chemical additive manufactured by synthesizing the various polymer molecules with the ceria slurry in a mixing ratio of 1:1, may be applied to various patterning processes required in the semiconductor process.

For example, the chemical additive, which is employed in planarization of a low density STI pattern, is obtained by synthesizing polyacrylic acid (PAA) or alkyl methacrylate of the polymeric molecule and acrylamide, methacrylamide, or ethyl-methacrylamide of the monomer. If the ceria slurry is mixed with the chemical additive to be used as an abrasive, polishing rate of oxide film is increased, and the selectivity of oxide film to nitride film is also increased, increasing the processing speed, i.e., polishing rate.

Furthermore, the chemical additive, which is employed in planarization of the high density STI pattern, is obtained by synthesizing polyacrylic acid (PAA) or alkyl methacrylate as the polymeric molecule and vinylpyridine, or vinylpyrrolidone as the monomer. Use of the chemical additive causes a passivation layer to be formed on a portion on the surface of a wafer where elements will be formed. The passivation layer can suppress the dishing phenomenon wherein oxide film is excessively removed due to loss of the nitride layer pattern. The passivation layer is formed for minimizing damage of the elements, which are easily caused by the narrow space between patterns.

If the chemical additive is mixed with the ceria slurry immediately before the CMP process of the semiconductor devices, the best result can be achieved as the CMP abrasive of the present invention.

Each of the components contained in the chemical additive is represented in detail in the following embodiments. Performance of the CMP abrasive according to each embodiment of the present invention is also represented.

### EMBODIMENT 1

Synthesized high purity ceria powder of 50 kg is mixed with ultra pure water of 150 kg in a high shear mixer. Then, the mixture is milled with a high energy attrition mill in order to control particle sizes thereof, and is dispersed with a high pressure dispersion apparatus. Next, ammonium polymethacrylate (available under the trade name DarvanC from R. T. Vanderbilt Company Inc.), as negative-ion-based polymeric compound, is added, wherein the added amount is 1% by weight of the ceria powder. Then, after the ceria slurry of 10% by weight is obtained by adding additional ultra pure water of 480 kg to the mixture and stirring it, in manufacturing a final slurry sample, the 10 kg ceria slurry of 2% by weight is obtained by mixing the 2 kg ceria slurry of 10% by weight and 8 kg ultra pure water. That is to say, the concentration of the abrasive particles is controlled to 2% by weight.

Separately from the forgoing, after mixing polyacrylic acid (PAA) of 0.3 kg and acrylamide of 0.05 kg with a small quantity of ultra pure water as solvent, and then reacting them, the chemical additive (in liquid phase) of about 10 kg is manufactured by adding the chemicals to an additional 9.5 kg of ultra pure water.

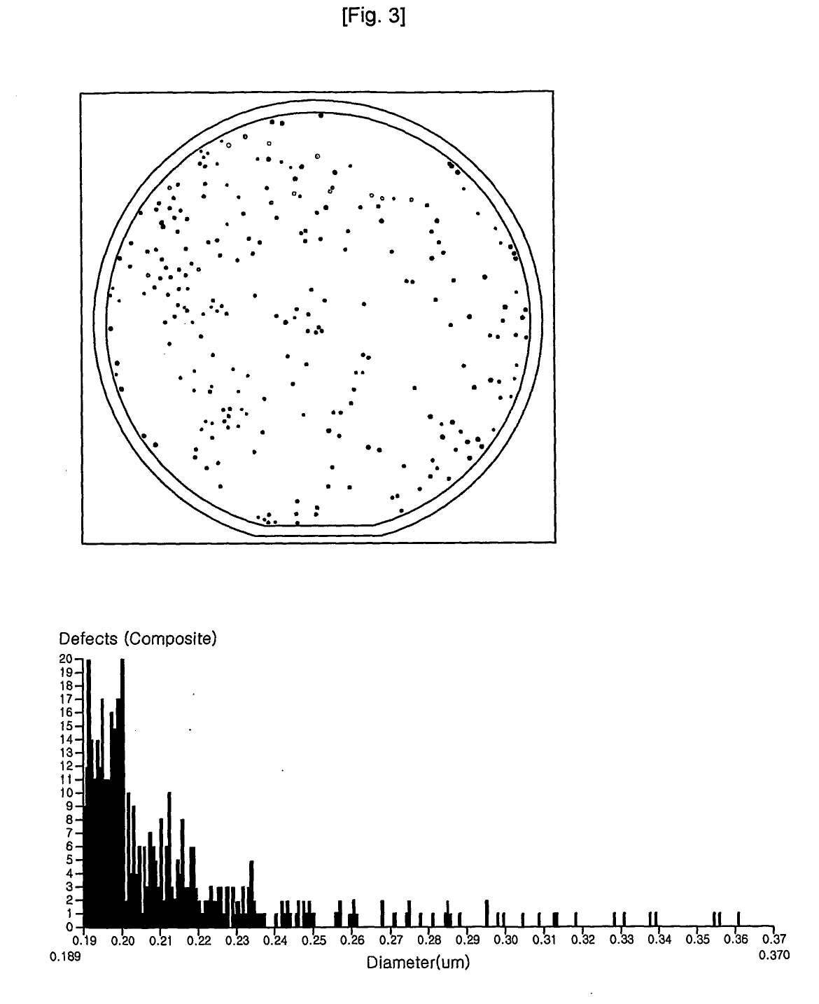

Subsequently, the ceria slurry manufactured previously is mixed with the chemical additive in a mixing ratio of 1:1. Properties of matter and polishing performance of the abrasive manufactured from the ceria slurry and the chemical additive by the above method and composition are represented in Tables 2 and 3 and FIGS. 3 to 6 along with comparative examples in detail.

### EMBODIMENTS 2 TO 10

While Embodiments 2 to 10 use the slurry manufactured by the same method as Embodiment 1, the chemical compounds as described in Table 1 as the chemical additive are mixed with the slurry. The mixing ratio of the slurry to the chemical additive is also 1:1 as in Embodiment 1.

TABLE 1
Kinds of chemical compounds in chemical
additive of each embodiment

| | Polymeric Molecule | Monomer |
|---|---|---|
| Embodiment 1 | Polyacrylic Acid (PAA) | Acrylamide |
| Embodiment 2 | Methacrylamide | |
| Embodiment 3 | Ethyl-Methacrylamide | |
| Embodiment 4 | Vinylpyridine | |
| Embodiment 5 | Vinylpyrrolidone | |
| Embodiment 6 | Alkyl Methacrylate | Acrylamide |
| Embodiment 7 | Methacrylamide | |
| Embodiment 8 | Ethyl-Methacrylamide | |
| Embodiment 9 | Vinylpyridine | |
| Embodiment 10 | Vinylpyrrolidone | |

### COMPARATIVE EXAMPLE 1

Comparative Example 1 is prepared by manufacturing the slurry by the same method as Embodiment 1 without adding a chemical additive.

In order to comparing the embodiments of the present invention with a commercially available abrasive, the test results of HS 8005 from Htachi Chemical Company, Ltd., as another comparative example, are represented along with the test results of the embodiments of the present invention and Comparative Example 1.

Comparative Test for Properties of Abrasives

Various kinds of tests for properties of the CMP abrasives according to Embodiments 1 to 10 and Comparative Example 1 and HS8005 were performed by using measuring instruments as follows:
1) Average Particle Size: N4 Plus from Coulter-Beckman Inc.

2) Dispersion Stability: N4 Plus from Coulter-Beckman Inc.

3) Viscosity: Viscometer DVII+ from Brookfield

4) Zeta Potential: Acousto-Sizer II from Colloidaldynamic

5) The Number of Particles: AccuSizer 780APS from PSS Inc.

The comparative test results for properties of the CMP abrasives according to Embodiments 1 to 10 and Comparative Example 1 and HS8005 are represented in Table 2 below.

TABLE 2
Test Results for Properties of CMP Abrasives

| | Average | | | | |
|---|---|---|---|---|---|
| | Particle | Dispersion | | Zeta | |
| | Size | Stability | Viscosity | Potential | Number % |
| | (nm) | (nm) | (cP) | (mV) | >1.09 μm |
| Embodiment 1 | 180 | 53 | 1.5 | −66 | 0.04% |
| Embodiment 2 | 183 | 54 | 1.4 | −66 | 0.04% |
| Embodiment 3 | 182 | 53 | 1.5 | −65 | 0.03% |
| Embodiment 4 | 185 | 53 | 1.5 | −65 | 0.04% |
| Embodiment 5 | 186 | 54 | 1.4 | −65 | 0.03% |
| Embodiment 6 | 182 | 52 | 1.5 | −65 | 0.03% |
| Embodiment 7 | 181 | 53 | 1.4 | −65 | 0.04% |
| Embodiment 8 | 183 | 54 | 1.5 | −67 | 0.03% |
| Embodiment 9 | 187 | 57 | 1.4 | −63 | 0.04% |
| Embodiment | 186 | 54 | 1.6 | −65 | 0.04% |
| 10 | | | | | |
| Comparative | 181 | 54 | 1.3 | −117 | 0.03% |
| Example 1 | | | | | |
| HS8005 | 260 | 48 | 1.5 | −52 | 0.12% |

Upon reviewing Table 2, while Embodiments 1 to 10 and Comparative Example 1 show good results in average particle size and dispersion stability, and the absolute values of the zeta potential of the embodiments are smaller than that of Comparative Example 1. That is the reason why adding the chemical additive causes the absolute values of the zeta potential to be decreased. However, since problem of abrasive stability may occur with the passage of the time, the slurry and the chemical additive are preferably mixed immediately before the CMP process as described above. Nevertheless, unless a chemical additive is added to the slurry, polishing of nitride film cannot be prevented, leading to residual particles and scratches.

Furthermore, as compared with HS8005 from Htachi, Embodiments 1 to 10 of the present invention have a smaller average particle size, better dispersion stability, larger absolute value of zeta potential, and fewer large particles over 1 μm, with the result that the present embodiments are superior to HS8005.

Tests of Polishing Performance

Tests of the polishing performances of the CMP abrasives according to Embodiments 1 to 10 and Comparative Example 1 and HS8005 were performed. 6EC from Strasbaugh was used as a CMP apparatus. For the tests, wafers with the oxide film were prepared by coating the entire surface of 8 inch wafers with PETEOS, and wafers with a nitride film were prepared by coating the entire surface of 8 inch wafers with Si₃N₄.

Conditions of the tests for the polishing performance are as follows:

1) Pad: IC1000/SUBAIV from Rodel Inc.

2) Film Thickness Gauge: Nano-Spec 180 from Nano-metrics Inc.

3) Table Speed: 70 rpm

4) Spindle Speed: 70 rpm

5) Downward Force: 4 psi

6) Back Pressure: 0 psi

7) Abrasive Supply Rate: 100 ml/min.

With the above conditions, after the wafers are polished for 1 minute with the respective abrasives, the polishing rates are obtained from the thickness removed by polishing. The polishing performance for each abrasive, which is represented in Table 3 below, is obtained by averaging three or more test results for each abrasive.

Furthermore, the number of micro scratches occurring on the surface of the wafer is measured by using Surfscan 6200 from KLA-Tencor Co. The test results of polishing performance of the CMP abrasives according to Embodiments 1 to 10 and Comparative Example 1 and HS8005 are represented in Table 3.

TABLE 3
Test results of Polishing Performance for Each Abrasive

| | | | Selectivity | | | | |
|---|---|---|---|---|---|---|---|
| | | | of | | | | |
| | Polishing | Polishing | Oxide | | Residual | Residual | |
| | Rate of | Rate of | Film to | | Particles | Particles | |
| | Oxide | Nitride | Nitride | WIWNU | of Oxide | of Nitride | Scratches |
| | Film (Å/min) | Film (Å/min) | Film | (%) | (#) | (#) | (#) |
| Embodiment 1 | 3,200 | 60 | 53:1 | 1.8 | 75 | 296 | 1 |
| Embodiment 2 | 3,210 | 59 | 54:1 | 1.9 | 63 | 225 | 1 |
| Embodiment 3 | 3,205 | 59 | 54:1 | 1.9 | 63 | 225 | 1 |
| Embodiment 4 | 2,780 | 50 | 55:1 | 1.9 | 63 | 225 | 0 |
| Embodiment 5 | 2,800 | 51 | 54:1 | 1.9 | 63 | 225 | 0 |
| Embodiment 6 | 3,200 | 61 | 54:1 | 1.9 | 63 | 225 | 1 |
| Embodiment 7 | 3,250 | 59 | 55:1 | 1.9 | 63 | 225 | 1 |
| Embodiment 8 | 3,190 | 60 | 53:1 | 1.9 | 63 | 225 | 1 |
| Embodiment 9 | 2,760 | 49 | 56:1 | 1.9 | 63 | 225 | 0 |
| Embodiment | 2,750 | 50 | 55:1 | 1.9 | 63 | 225 | 1 |
| 10 | | | | | | | |
| Comparative | 3,800 | 520 | 7:1 | 4.7 | 356 | 278 | 3 |
| Example 1 | | | | | | | |
| HS8005 | 2,500 | 55 | 45:1 | 1.9 | 529 | 543 | 4 |

Upon reviewing the test results described in Table 3, the abrasives of Embodiments 1 to 10 have the higher polishing rate of the oxide film and about ten higher selectivity than HS8005 from Htachi. Especially, the abrasives of the present embodiments show good results in the properties regarding residual particles and scratches. However, since the abrasives of Embodiments 4, 5, 9 and 10, wherein the vinyl-based monomer is mixed in the chemical additive, are suitable for high density patterns, these abrasives have a slightly lower polishing rate of the oxide film as compared with the other embodiments. Nevertheless, since the polishing rates of the nitride film of the abrasives of Embodiments 4, 5, 9 and 10 are also lower, loss of elements can be minimized. Since the abrasive of Comparative Example 1 does not contain a chemical additive, its polishing rate of the nitride film is higher and thus its selectivity is lower. The abrasive of Comparative Example 1 also has poor properties regarding residual particles and scratches.

In the meantime, FIGS. 3 to 6 show the test results of the properties regarding residual particles and scratches of the conventional abrasive (HS8005 from Htachi) and the abrasive of the embodiment according to the present invention

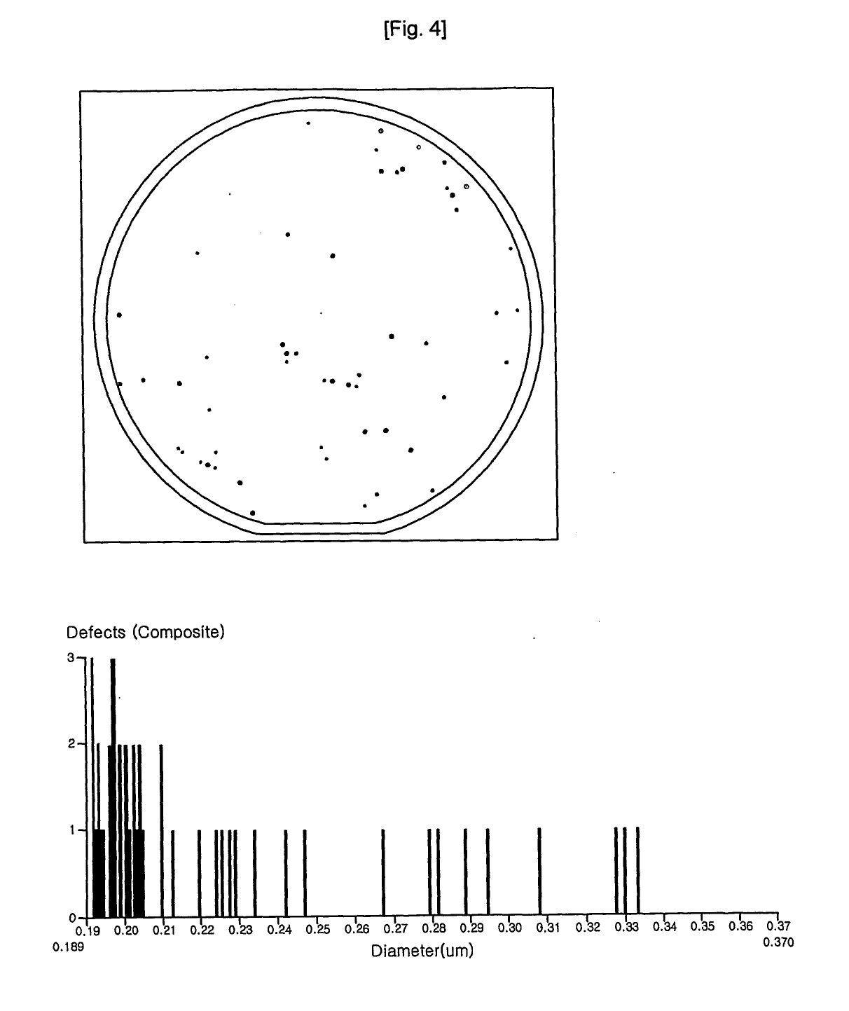

FIGS. 3 and 4 show the test results of the properties regarding residual particles from oxide film and scratches of the conventional abrasive (HS8005 from Htachi) and the abrasive according to Embodiment 1 of the present invention, respectively.

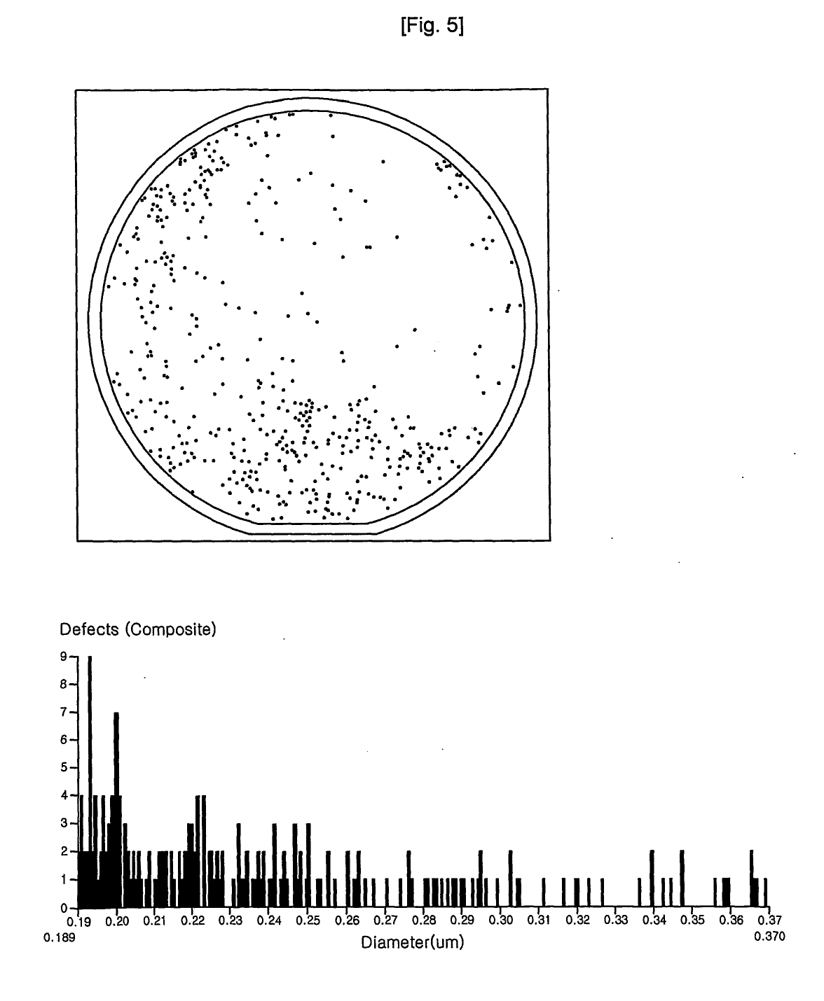

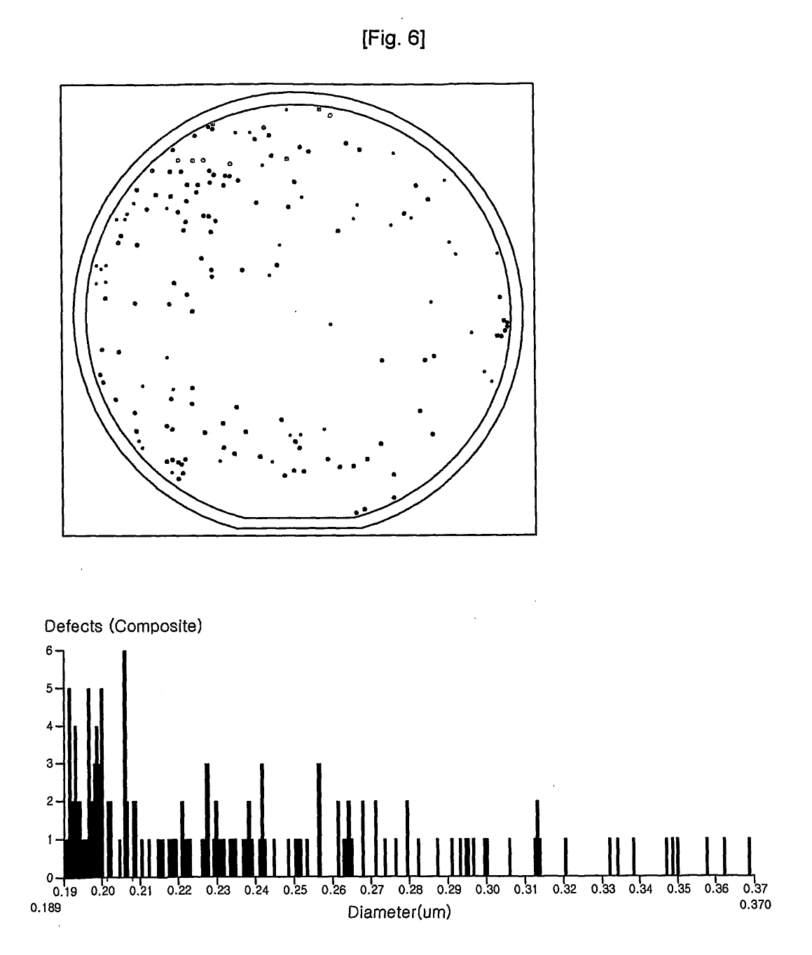

FIGS. 5 and 6 show the test results of the properties regarding residual particles from nitride film and scratches of the conventional abrasive (HS8005 from Htachi) and the abrasive according to the embodiment of the present invention, respectively.

Residual particles are counted after scanning the surface of the wafer with a laser, while scratches are found and counted with the naked eye. As shown in FIGS. 3 to 6, as compared with the wafers polished with HS8005, fewer residual particles from the nitride and oxide films and fewer scratches are found in the wafers polished with the abrasive according to the embodiment of the present invention. It is noted that in the distributions of residual particles according to the size thereof, the abrasive of the present invention has fewer defects than HS8005 from Htachi.

### EMBODIMENT 11

In order to confirm the results of the CMP process according to the concentration of chemical additives in the CMP abrasive of the present invention, the respective chemical additives for a low density pattern and a high density pattern are manufactured with the added amounts of the chemical compounds of the polymeric molecule and monomer varying at 3%, 5% and 10% by solvent weight. The test results of the polishing properties of the abrasives according to the respective chemical additives are represented in Table 4.

TABLE 4
Test results of CMP process according to concentration of chemical
additives

| | | 10 wt % | 5 wt % | 3 wt % |
|---|---|---|---|---|
| Chemical | Removal Rate | 2,310 | 2,780 | 3,170 |
| Additive for | for Oxide (Å/min) | | | |
| Low Density | | | | |
| Pattern | | | | |
| Removal Rate | 45 | 53 | 59 | |
| for Nitride (Å/min) | | | | |
| Chemical | Removal Rate | 2,010 | 2,530 | 2,800 |
| Additive for | for Oxide (Å/min) | | | |
| High Density | | | | |
| Pattern | | | | |
| Removal Rate | 42 | 45 | 51 | |
| for Nitride (Å/min) | | | | |

It is understood from Table 4 that as the concentration of chemical additives is decreased, the removal rate of the oxide in the polishing process is increased. Since in a practical polishing process, the removal rate for oxide is preferably 2,000 or more, and more preferably 2,500 or more taking yield into consideration, the concentration of chemical additives is preferably 5% by weight or less. In addition, the 3% by weight concentration of the chemical additives has the high removal rate of the oxide and the appropriate removal rate of the nitride, with the result that the preferable polishing process can be performed.

### Industrial Applicability

As described above, according to the present invention, it is possible to manufacture an abrasive, which has superior properties of matter essentially required as an STI CMP abrasive. Therefore, when the abrasive according to the present invention is used as an STI CMP abrasive, it is possible to apply the abrasive to the patterning process required in the very large scale integration semiconductor process.

Furthermore, the CMP abrasive of the present invention has a superior removal rate, superior polishing selectivity, superior within wafer non-uniformity (WIWNU), and minimized occurrence of micro scratches.

1. A CMP abrasive comprising:
a ceria slurry; and
a chemical additive having two or more functional groups by mixing and synthesizing a polymeric molecule and a monomer.

2. A CMP abrasive as defined in claim 1, wherein said ceria slurry comprises ceria powder, water and negative-ion-based polymeric compound and conforms to a Newtonian viscosity behavior.

3. A CMP abrasive as defined in claim 2, wherein said negative-ion-based polymeric compound is selected from the group consisting of polymethacrylic acid, ammonium polymethacrylate, polycarboxylate and carboxyle-acryl polymer.

4. A CMP abrasive as defined in claim 1, wherein in said chemical additive, said polymeric molecule is polyacrylic acid (PAA), and said monomer is selected from the group consisting of acrylamide, methacrylamide and ethyl-methacrylamide.

5. A CMP abrasive as defined in claim 4, wherein mixing ratio of said slurry to said chemical additive is 1:1.

6. A CMP abrasive as defined in claim 1, wherein in said chemical additive, said polymeric molecule is polyacrylic acid (PAA), and said monomer is vinylpyridine or vinylpyrrolidone.

7. A CMP abrasive as defined in claim 6, wherein mixing ratio of said slurry to said chemical additive is 1:1.

8. A CMP abrasive as defined in claim 1, wherein in said chemical additive, said polymeric molecule is alkyl methacrylate, and said monomer is selected from the group consisting of acrylamide, methacrylamide and ethyl-methacrylamide.

9. A CMP abrasive as defined in claim 8, wherein mixing ratio of said slurry to said chemical additive is 1:1.

10. A CMP abrasive as defined in claim 1, wherein in said chemical additive, said polymeric molecule is alkyl methacrylate, and said monomer is vinylpyridine or vinylpyrrolidone.

11. A CMP abrasive as defined in claim 10, wherein mixing ratio of said slurry to said chemical additive is 1:1.

12. A method for manufacturing CMP abrasive comprising steps of:
providing a ceria slurry;
manufacturing a chemical additive having two or more functional groups by mixing and synthesizing a polymeric molecule and a monomer in a reactor; and
mixing said slurry and said chemical additive.

13. A method for manufacturing CMP abrasive as defined in claim 12, wherein said step of providing a ceria slurry comprising steps of:
manufacturing ceria by solid-phase synthesis;
mixing said ceria with water;
milling said mixture with a high energy attrition mill;
dispersing said milled resultant with a high pressure dispersion apparatus; and
dispersion stabilizing said dispersed resultant by adding negative-ion-based polymeric compound.

14. A method for manufacturing CMP abrasive as defined in claim 13, wherein said negative-ion-based polymeric compound is selected from the group consisting of polymethacrylic acid, ammonium polymethacrylate, polycarboxylate, and carboxyle-acryl polymer.

15. A method for manufacturing CMP abrasive as defined in claim 13, wherein said negative-ion-based polymeric compound of 0.0001˜10% by weight is added.

16. A method for manufacturing CMP abrasive as defined in claim 13, after said step of dispersion stabilizing, further comprising a step of removing large particles with a filter.

17. A method for manufacturing CMP abrasive as defined in claim 12, wherein the molecular weight of the polymeric molecule is 2,000˜1,000,000.

18. A method for manufacturing CMP abrasive as defined in claim 12, wherein said step of manufacturing the chemical additive further comprises a step of adding further solvent to the synthesized chemical additive.

19. A method for manufacturing CMP abrasive as defined in claim 18, wherein said step of adding further solvent causes the synthesized chemical additive to be 0.03˜10% by weight.

20. A method for manufacturing CMP abrasive as defined in claim 12, wherein in said chemical additive, said polymeric molecule is polyacrylic acid (PAA) or alkyl methacrylate, and said monomer is selected from the group consisting of acrylamide, methacrylamide, ethyl-methacrylamide, vinylpyridine, and vinylpyrrolidone.

21. A method for manufacturing CMP abrasive as defined in claim 20, wherein the mixing ratio of said slurry to said chemical additive is 1:1.
